(19) United States
(12) Patent Application Publication
(10) Pub. No.: US 2026/0191267 A1
(43) Pub. Date: Jul. 9, 2026

(54) ATOMIZER AND ELECTRONIC ATOMIZATION DEVICE

(71) Applicant: SHENZHEN SMOORE TECHNOLOGY LIMITED, Shenzhen (CN)

(72) Inventors: Yayun CHEN, Shenzhen (CN); Weidong ZHOU, Shenzhen (CN); Fengwen LU, Shenzhen (CN); Yingming LIU, Shenzhen (CN)

(21) Appl. No.: 19/437,757

(22) Filed: Dec. 31, 2025

(30) Foreign Application Priority Data
Jan. 3, 2025 (CN) 202520018841.9

(51) Int. Cl. A24F 40/46; A24F 40/48; H05B 3/24

(52) U.S. Cl. CPC A24F 40/46; A24F 40/48; H05B 3/24; H05B 2203/007

(57) ABSTRACT

An atomizer includes: an atomization base, the atomization base being provided with an airflow channel, the airflow channel having an air inlet hole, an air outlet hole, and an atomization cavity, the atomization cavity being respectively in communication with the air inlet hole and the air outlet hole, an airflow guiding structure being provided in the atomization cavity, the airflow guiding structure being disposed toward the air outlet hole; and an atomization core disposed on the atomization base and being in fluid communication with the atomization cavity, the atomization core including at least two heating elements, adjacent heating elements of the at least two heating elements being spaced apart.

### CROSS-REFERENCE TO PRIOR APPLICATION

Priority is claimed to Chinese Patent Application No. 202520018841.9, filed on January 3, 2025, the entire application of which is hereby incorporated by reference herein.

### FIELD

The present application relates to the field of atomization technologies, and in particular to an atomizer and an electronic atomization device.

### BACKGROUND

An electronic atomization device is a device that atomizes an aerosol generating substrate into an aerosol. With the development of atomization technologies, users have increasingly higher requirements on electronic atomization devices. An existing electronic atomization device is typically a single-core product, that is, has only one atomization core. When a single atomization core has an excessively large heating power, the aerosol is prone to producing a burnt or scorched taste, so it is impossible to achieve a large heating power. When the atomization core has a relatively small power, the atomization efficiency is low. Therefore, the existing electronic atomization device generally has defects of small vapor generation amount and low vapor generation rate, and thus fail to deliver a satisfactory puffing experience to the user.

### SUMMARY

In an embodiment, the present invention provides an atomizer, comprising: an atomization base, the atomization base being provided with an airflow channel, the airflow channel having an air inlet hole, an air outlet hole, and an atomization cavity, the atomization cavity being respectively in communication with the air inlet hole and the air outlet hole, an airflow guiding structure being provided in the atomization cavity, the airflow guiding structure being disposed toward the air outlet hole; and an atomization core disposed on the atomization base and being in fluid communication with the atomization cavity, the atomization core comprising at least two heating elements, adjacent heating elements of the at least two heating elements being spaced apart.

### BRIEF DESCRIPTION OF THE DRAWINGS

Subject matter of the present application will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural view of an electronic atomization device in some embodiments of the present application;

FIG. 2 is a schematic vertical sectional structural view of the electronic atomization device shown in FIG. 1;

FIG. 3 is a schematic exploded structural view of the electronic atomization device shown in FIG. 1;

FIG. 4 is a schematic three-dimensional structural view of an atomization base of the electronic atomization device shown in FIG. 3;

FIG. 5 is a schematic vertical sectional structural view of the atomization base shown in FIG. 4;

FIG. 6 is a schematic exploded structural view of the atomization base shown in FIG. 4;

FIG. 7 is a schematic vertical sectional structural view of the atomization base shown in FIG. 6;

FIG. 8 is a schematic three-dimensional structural view of a base of the atomization base shown in FIG. 4;

FIG. 9 is a schematic three-dimensional structural view of the base in some other embodiments;

FIG. 10 is a schematic three-dimensional structural view of a heating element in some embodiments of the present application;

FIG. 11 is a schematic three-dimensional structural view of the heating element in some other embodiments of the present application; and

FIG. 12 is a schematic diagram of TPM test results of an atomization core in some embodiments of the present application.

### DETAILED DESCRIPTION

In an embodiment, the present invention provides an improved atomizer and an electronic atomization device in view of at least one defect proposed in the background art.

In an embodiment, the present invention provides an atomizer, including an atomization base and an atomization core.

The atomization base is provided with an airflow channel. The airflow channel includes an air inlet hole, an air outlet hole, and an atomization cavity. The atomization cavity is respectively in communication with the air inlet hole and the air outlet hole. An airflow guiding structure is provided in the atomization cavity. The airflow guiding structure is disposed toward the air outlet hole.

The atomization core is disposed on the atomization base and is in fluid communication with the atomization cavity. The atomization core includes at least two heating elements. The adjacent heating elements are spaced apart.

In some embodiments, the atomization base includes a base and a holder. The base and the holder jointly enclose to form the atomization cavity. The airflow guiding structure is formed on the base.

In some embodiments, the atomization core is disposed the holder.

The base is provided with first mounting holes, and the first mounting holes run through the surface of the base facing the atomization core and the surface of the base facing away from the atomization core.

The atomizer further includes a first circuit board configured to connect to a power supply unit. The first circuit board is disposed on the side of the base facing away from the atomization core. A plurality of conductive posts are disposed on the first circuit board. The conductive posts are connected to the heating elements after passing through the first mounting holes.

In some embodiments, the holder includes a main body and support legs connected to each other, and the atomization core is disposed on the main body.

The support legs are at least partially located on the side of the base facing away from the atomization core, and the first circuit board abuts against the support legs; and/or the main body is provided with a plurality of vias in one-to-one correspondence with the conductive posts, and the conductive posts are connected to the heating elements after sequentially passing through the first mounting holes and the vias.

In some embodiments, the airflow guiding structure is convexly disposed on a cavity bottom surface of the atomization cavity. The airflow guiding structure has an airflow guiding surface. The airflow guiding surface includes at least one of an inclined surface and a conical surface.

In some embodiments, the at least two heating elements are spaced apart along two opposite sides of the airflow guiding structure.

In some embodiments, each of the heating elements includes a conductive portion and at least one heating portion connected to the conductive portion.

In some embodiments, each of the heating elements includes at least two heating portions, and at least two of the heating portions are electrically connected in parallel; and/or

at least two of the heating elements are electrically connected in parallel.

In some embodiments, each of the heating elements is sheet-shaped. The present application further provides an electronic atomization device, including a power supply unit and the atomizer according of any one of the foregoing aspects. The atomizer is connected to the power supply unit.

The present application has at least the following beneficial effects: Because the atomization core includes at least two heating elements and the at least two heating elements respectively heat the aerosol generating substrate, the atomization core can provide uniform heating, and the vapor generation amount can be increased, and the risk of burning of the atomization core can be reduced. Because the airflow guiding structure disposed opposite to the air outlet hole is disposed in the atomization cavity, the airflow guiding structure is configured to change the flow direction of the aerosol in the atomization cavity and increase the flow speed of the aerosol to rapidly guide out the mixed fluid of the aerosol and air through the air outlet hole, thereby increasing the vapor generation rate and reducing the aerosol temperature and the taste loss rate. Because the vapor generation amount and the vapor generation rate are increased, the vapor generation amount of each puff is effectively increased, and the aerosol is ensured to have a good taste, thereby improving user experience.

In order to have a clearer understanding of the technical features, the objectives, and the effects of the present application, specific implementations of the present application are now illustrated in detail with reference to the accompanying drawings.

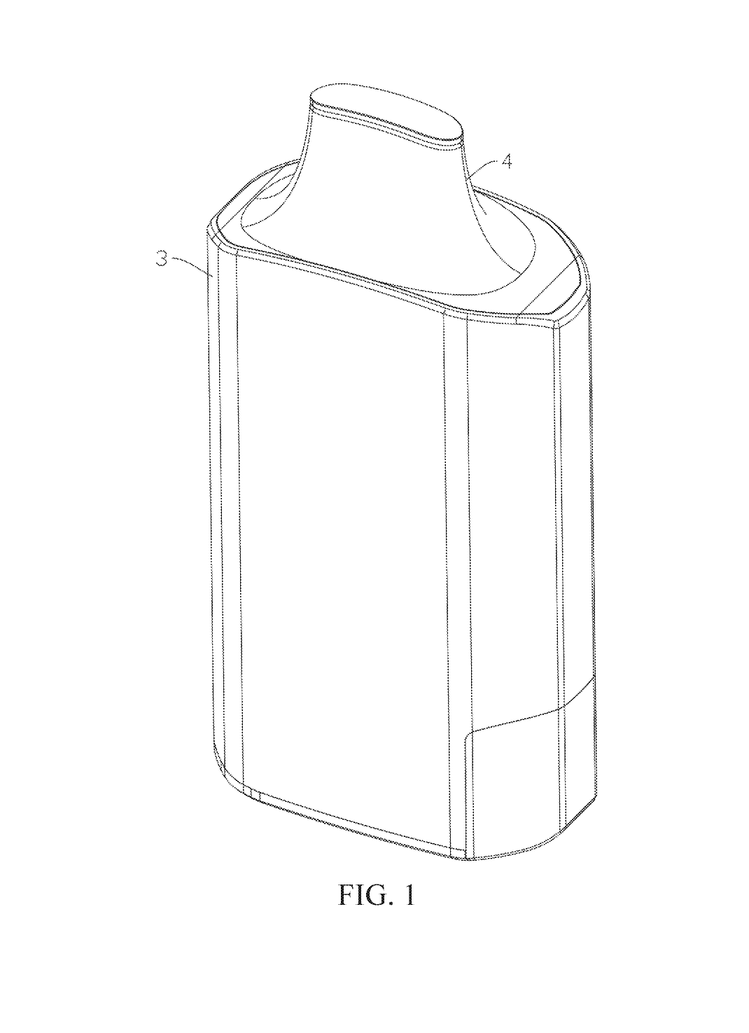

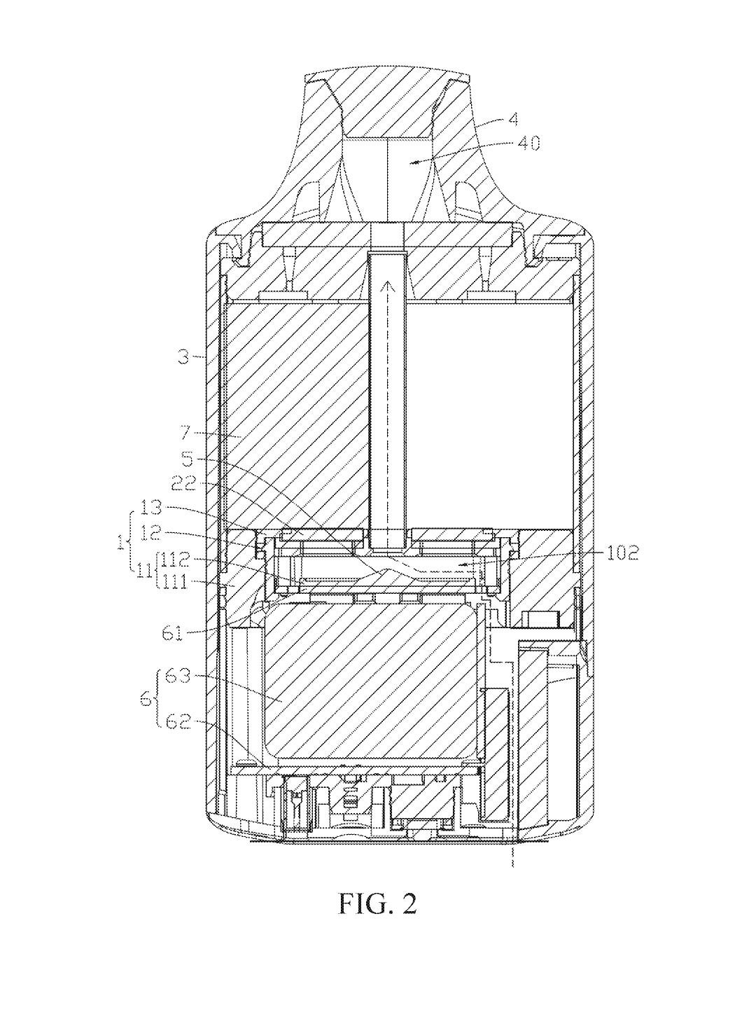

FIG. 1 and FIG. 2 show an electronic atomization device in an embodiment of the present application. The electronic atomization device includes a power supply unit 6 and an atomizer. The atomizer is connected to the power supply unit 6. The power supply unit 6 includes a second circuit board 62 and a battery cell 63. The battery cell 63 is connected to the second circuit board 62, and the battery cell 63 is configured to store electric energy. The second circuit board 62 is a main control board. The second circuit board 62 is configured to control startup (on/off) of the atomizer, control an external power supply to charge the battery cell 63, and the like. Specifically, the atomizer and the power supply unit 6 may be detachably connected together. Alternatively, the atomizer and the power supply unit 6 may also be a whole that is difficult to disassemble. The atomizer and the power supply unit 6 can form an electrical connection. The atomizer is configured to heat and atomize, in an on state, an aerosol generating substrate, to generate an aerosol for a user to puff. The aerosol generating substrate may be liquid, solid, pasty, or the like.

FIG. 1 to FIG. 3 show an atomizer in an embodiment of the present application. The atomizer includes a shell 3, and an atomization base 1 and an atomization core 2 that are disposed in the shell 3. The atomization core 2 and the power supply unit 6 can form an electrical connection. The atomization core 2 is configured to heat and atomize, in an on state, an aerosol generating substrate, to generate an aerosol. The atomization base 1 is configured to provide a spreading space for the aerosol generated by the atomization core 2 and guide out the aerosol.

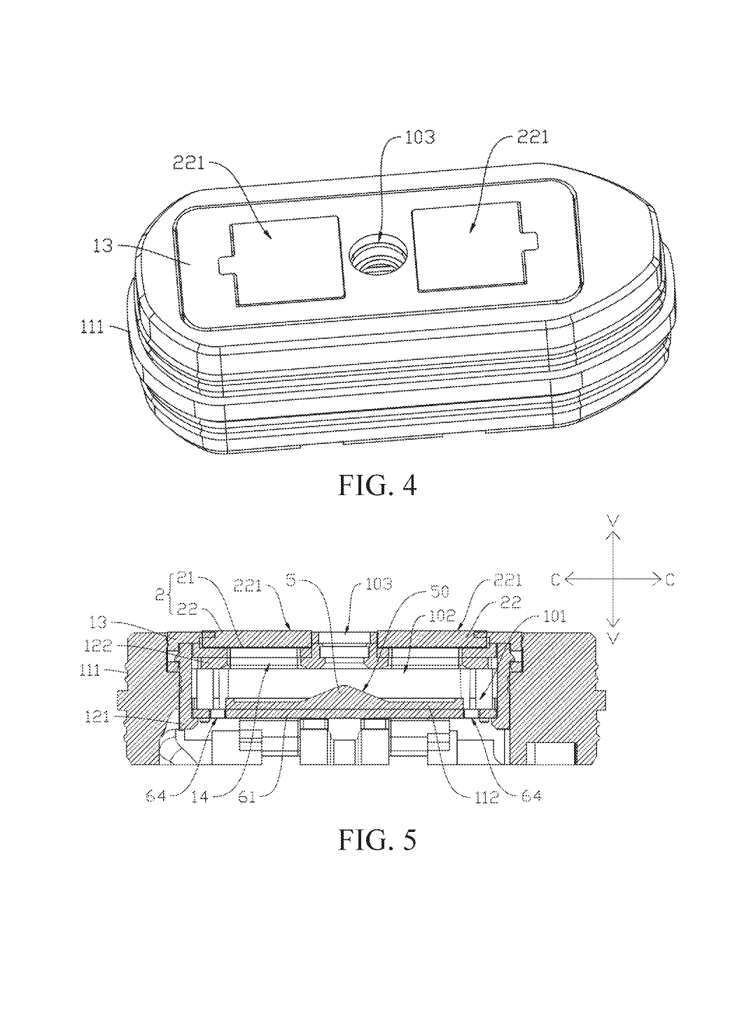

Referring to FIG. 4 to FIG. 7, the atomization base 1 is provided with an airflow channel, and the airflow channel includes an air inlet hole, an air outlet hole 103, and an atomization cavity 102. The atomization cavity 102 is respectively in communication with the air inlet hole and the air outlet hole 103. That is, the air inlet hole, the atomization cavity 102, and the air outlet hole 103 are in communication in sequence, to form the airflow channel. The air inlet hole is in communication with the atmosphere, and air from the outside can flow into the atomization cavity 102 through the air inlet hole and then flow out through the air outlet hole 103. The atomization cavity 102 is configured to provide a spreading space for the aerosol generated by the atomization core 2. The atomization core 2 is disposed on the atomization base 1 and is in fluid communication with the atomization cavity 102. That is, the fluid can flow between the atomization core 2 and the atomization cavity 102. The fluid refers to a material that can flow continuously, and includes a liquid, a gas, and an aerosol. After the atomization core 2 heats the aerosol generating substrate, the generated aerosol spreads into the atomization cavity 102 and is mixed with the airflow in the airflow channel. The mixed fluid of the aerosol and the airflow in the airflow channel flows out through the air outlet hole 103 for the user to puff.

In a conventional atomization core 2, a single heating element 21 is usually used to heat an aerosol generating substrate, resulting in the small vapor generation amount. The only method to increase the vapor generation amount is to increase the heating power of the atomization core 2. However, heat generated by the resistive heating element 21 tends to be concentrated. When the power of the single heating element 21 is excessively large, the atomization core 2 is prone to burning, producing a burnt or scorched taste, which affects user experience. To solve this problem, the atomization core 2 of the present application includes at least two heating elements 21, and the adjacent heating elements 21 are spaced apart on the periphery of the air outlet hole 103. That is, the quantity of the heating elements 21 may be two, three, four, or the like. Each heating element 21 generates heat in an on state, and after coming into contact with the heating element 21 in a heating state, the aerosol generating substrate is heated and atomized, so as to generate the aerosol. The at least two heating elements 21 are disposed to respectively heat the aerosol generating substrate, so that the power of the single heating element 21 is not excessively large, but the sum of the powers (total power) of the heating elements 21 can be increased. In this way, the atomization core 2 can provide uniform heating, the vapor generation amount can be increased, and the risk of burning of the atomization core 2 can be reduced.

Further, an airflow guiding structure 5 is provided in the atomization cavity 102, and the airflow guiding structure 5 is disposed toward the air outlet hole 103. Specifically, the airflow guiding structure 5 may be disposed right below the air outlet hole 103, that is, the projections of the airflow guiding structure 5 and the air outlet hole 103 in the vertical direction at least partially overlap. For the vertical direction, reference may be made to the V-V direction in FIG. 5. The airflow guiding structure 5 is configured to change the flow direction of the aerosol in the atomization cavity 102 and increase the flow speed of the aerosol to rapidly guide out the mixed fluid of the aerosol and air through the air outlet hole 103, thereby increasing the vapor generation rate. Because the vapor generation rate is increased, the aerosol temperature and the taste loss rate are reduced.

In conclusion, because the atomization core 2 includes at least two heating elements 21 and the at least two heating elements 21 respectively heat the aerosol generating substrate, the atomization core 2 can provide uniform heating, and the vapor generation amount can be increased, and the risk of burning of the atomization core 2 can be reduced. Because the airflow guiding structure 5 disposed opposite to the air outlet hole 103 is disposed in the atomization cavity 102, the airflow guiding structure 5 is configured to change the flow direction of the aerosol in the atomization cavity 102 and increase the flow speed of the aerosol to rapidly guide out the mixed fluid of the aerosol and air through the air outlet hole 103, thereby increasing the vapor generation rate and reducing the aerosol temperature and the taste loss rate. Because the vapor generation amount and the vapor generation rate are increased, the vapor generation amount of each puff is effectively increased, and the aerosol is ensured to have a good taste, thereby improving user experience.

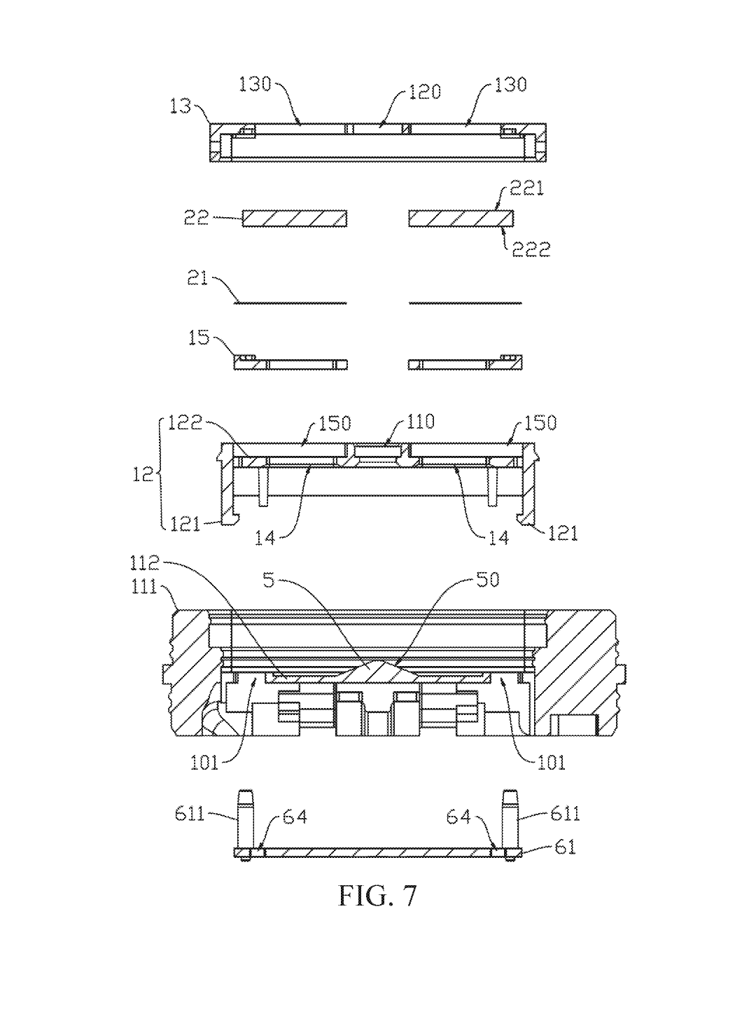

As shown in FIG. 5 and FIG. 7, in some embodiments, the at least two heating elements 21 are spaced apart along two opposite sides of the airflow guiding structure 5. For example, in the embodiment shown in FIG. 5, the two heating elements 21 are respectively located on two opposite sides of the airflow guiding structure 5 along the horizontal direction. For the horizontal direction, reference may be made to the C-C direction in FIG. 5. That is, the two heating elements 21 are respectively located on the left side and the right side of the airflow guiding structure 5 in the horizontal direction. When more than two heating elements 21 are disposed, any two of the heating elements 21 may be located on the two opposite sides of the airflow guiding structure 5 in the horizontal direction. In this way, the vapor generation directions of the heating elements 21 are different relative to the airflow guiding structure 5, helping fully mix the aerosol and the air in the atomization cavity 102 and helping ensure consistent taste of the aerosol. The airflow guiding structure guides the aerosol (vapor) from different directions to the position of the air outlet hole 103.

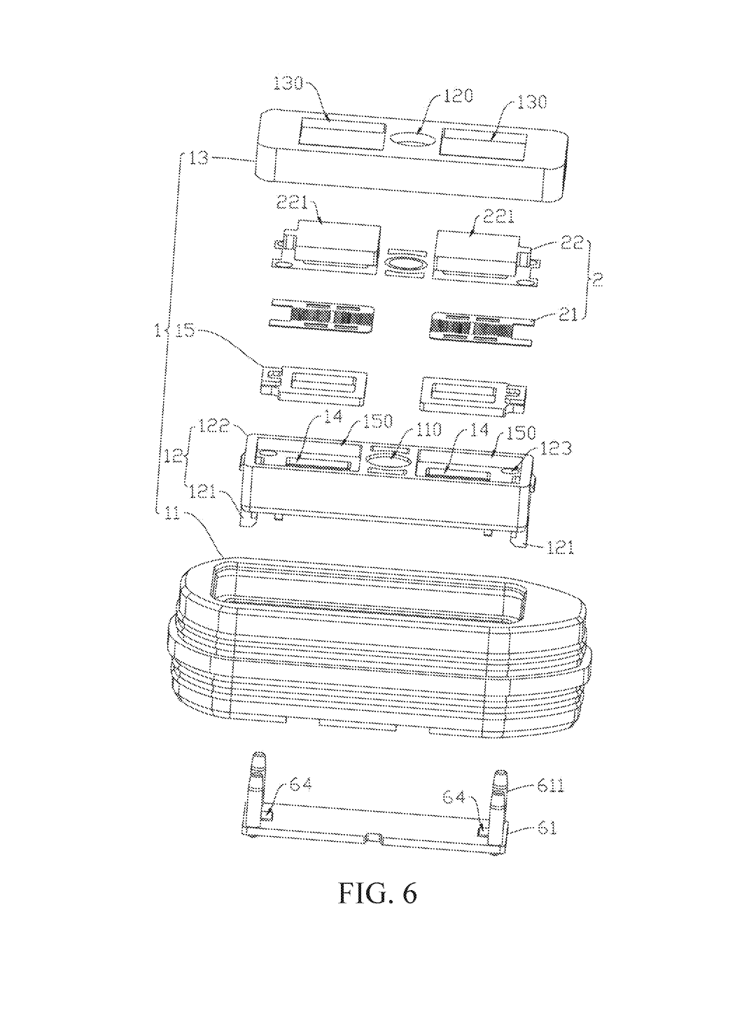

As shown in FIG. 5, in some embodiments, the atomization base 1 is provided with at least two through holes 14 in communication with the atomization cavity 102. The through holes 14 are in one-to-one correspondence with the heating elements 21. The atomization core 2 is in fluid communication with the atomization cavity 102 through the through holes 14. That is, the quantity of the through holes 14 is the same as the quantity of the heating elements 21. Each heating element 21 is correspondingly disposed at one through hole 14, and is exposed to the atomization cavity 102 through the through hole 14. Therefore, the aerosol generated at the heating element 21 can spread into the atomization cavity 102. Specifically, in the embodiment shown in FIG. 6 and FIG. 7, two through holes 14 and two heating elements 21 are provided in total. The two through holes 14 are respectively disposed on two opposite sides of the periphery of the air outlet hole 103, so that the heating elements 21 are disposed on two opposite sides of the periphery of the air outlet hole 103. Certainly, in some other embodiments, the through holes 14 may alternatively be arranged spaced apart on the periphery of the air outlet hole 103 along the circumferential direction of the air outlet hole 103. Alternatively, the through holes 14 may also be asymmetrically disposed on the outer side of the air outlet hole 103.

Specifically, as shown in FIG. 5 to FIG. 7, in some embodiments, the atomization base 1 includes a base 11 and a holder 12. The base 11 and the holder 12 are mounted together to jointly enclose to form the atomization cavity 102. The atomization core 2 is disposed on the holder 12. The airflow guiding structure 5 is formed on the surface of the base 11 facing the atomization core 2. Further, the through holes 14 are also formed in the holder 12. The atomization core 2 may be mounted to the holder 12 from the side of the holder 12 facing away from the base 11. The base 11 may be an elastic member made of, for example, silicone, rubber, or silicone rubber.

As shown in FIG. 5 to FIG. 8, in some embodiments, the base 11 is provided with first mounting holes 101. The first mounting holes 101 run through the surface of the base 11 facing the atomization core 2 and the surface of the base facing away from the atomization core 2. The first mounting holes 101 may serve as air inlet holes in communication with the atomization cavity 102. Alternatively, in some other embodiments, the air inlet holes may also be provided at other positions on the base 11. Specifically, the base 11 includes an annular side wall 111 and a bottom wall 112 connected to each other. The bottom wall 112 extends along the horizontal direction. The airflow guiding structure 5 is formed on the surface of the bottom wall 112 facing the atomization core 2.

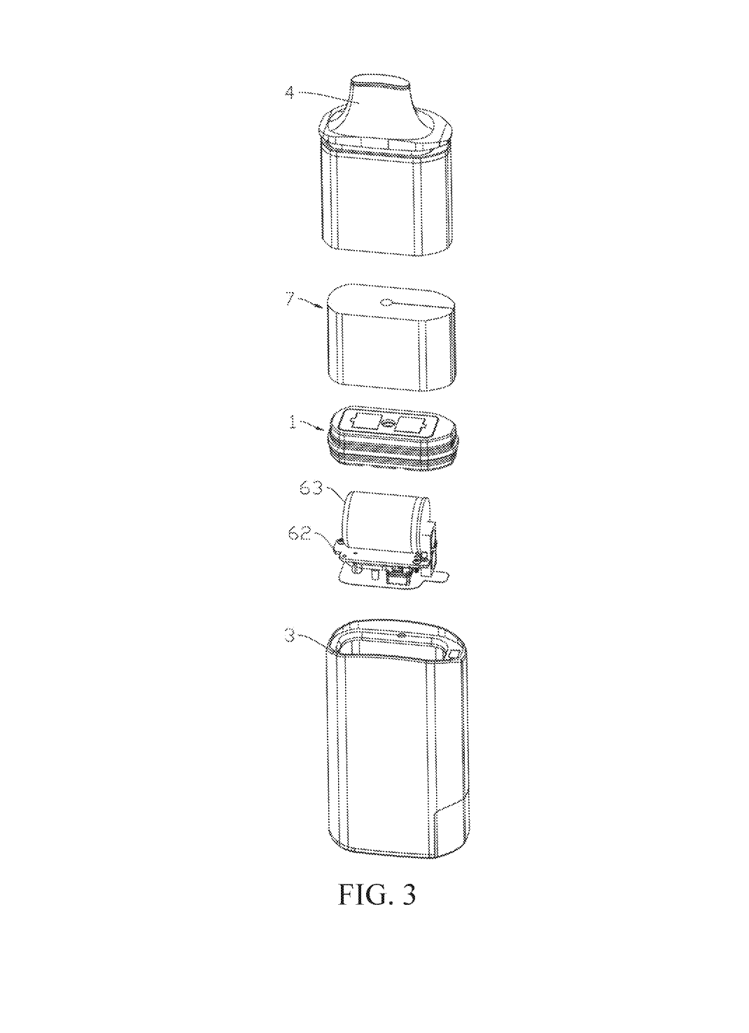

The atomizer further includes a first circuit board 61 configured to connect to the power supply unit 6. The first circuit board 61 is disposed on the side of the base 11 facing away from the atomization core 2. Specifically, the first circuit board 61 is disposed on the surface of the base 11 facing away from the holder 12. Further, as shown in FIG. 2 and FIG. 3, the battery cell 63 and the second circuit board 62 are disposed on the side of the first circuit board 61 away from the base 11. Besides, the battery cell 63 is located between the first circuit board 61 and the second circuit board 62. On one hand, the first circuit board 61 is connected to the second circuit board 62. On the other hand, the first circuit board 61 is provided with a plurality of conductive posts 611, and the conductive posts 611 are connected to the heating elements 21 after passing upward through the first mounting holes 101. That is, the first circuit board 61 is connected to the heating elements 21 through the conductive posts 611. The second circuit board 62 may serve as a main control board for controlling operation of the heating elements 21, and the first circuit board 61 serves as a connection medium between the heating elements 21 and the second circuit board 62.

Specifically, the conductive post 611 abuts against the heating element 21 with the end away from the first circuit board 61. Corresponding to the at least two heating elements 21, the quantity of the conductive posts 611 is at least three, and every two conductive posts 611 respectively serve as a positive electrode and a negative electrode. In the embodiment shown in FIG. 6, four conductive posts 611 are provided in total. Two of the conductive posts 611 are connected to one of the heating elements 21, and the other two of the conductive posts 611 are connected to the other heating element 21. Alternatively, one of the conductive posts 611 may also be connected to both of the two heating elements 21 and serve as a common electrode of the two heating elements 21.

As shown in FIG. 5 to FIG. 7, in some embodiments, the airflow channel further includes air guide holes 64 provided in the first circuit board 61. The air guide holes 64 run through the first circuit board 61 along the thickness direction of the first circuit board 61. The air guide holes 64 are in communication with the air inlet holes (for example, the first mounting holes 101). Air in the atmosphere outside the atomizer enters the atomization cavity 102 sequentially through the air guide holes 64 and the air inlet holes (for example, the first mounting holes 101), to carry out the aerosol in the atomization cavity 102 through the air outlet holes 103.

As shown in FIG. 5 to FIG. 7, in some embodiments, the holder 12 includes a main body 122 and support legs 121 connected to each other. The atomization core 2 is disposed on the main body 122. Specifically, the main body 122 approximately has a frame structure, and includes a platform extending in the horizontal direction and a side wall extending in the vertical direction. The support legs 121 are connected to the side wall. The atomization core 2 is disposed on the platform extending in the horizontal direction. The support legs 121 are at least partially located on the side of the base 11 facing away from the atomization core 2. Specifically, the support legs 121 are at least partially located on the side of the bottom wall 112 of the base 11 facing away from the atomization core 2. That is, the support legs 121 may be partially or entirely located on the side of the bottom wall 112 facing away from the atomization core 2. The first circuit board 61 abuts against the support legs 121. Specifically, the support leg 121 is approximately L-shaped. The end of the support leg away from the side wall of the main body 122 is formed with a step extending in the horizontal direction. An edge of the first circuit board 61 abuts the step. Therefore, the first circuit board 61 is fixed to the side of the base 11 facing away from the atomization core 2 through the support legs 121.

In the embodiment shown in FIG. 5 to FIG. 7, the holder 12 includes two support legs 121 disposed on two sides of the side wall of the main body 122 along the horizontal direction. The base 11 is provided with two first mounting holes 101 in total, and the two first mounting holes 101 are respectively located on two opposite sides of the airflow guiding structure 5 along the horizontal direction. The two support legs 121 and the two first mounting holes 101 are in one-to-one correspondence. When the holder 12 is mounted into the base 11, each support leg 121 passes through the first mounting hole 101 and then reaches the side of the base 11 facing away from the atomization core 2. Specifically, each support leg 121 passes through the first mounting hole 101 and then reaches the side of the bottom wall 112 of the base 11 facing away from the atomization core 2. At the same time, the main body 122 of the holder 12 may abut against the bottom wall 112 of the base 11.

As shown in FIG. 6, in some embodiments, the main body 122 is provided with a plurality of vias 123 in one-to-one correspondence with the conductive posts 611. That is, the quantity of the vias 123 is equal to the quantity of the conductive posts 611. Each conductive post 611 corresponds to one via 123. The conductive post 611 is connected to the heating element 21 after sequentially passing through the first mounting hole 101 and the via 123. Specifically, the vias 123 are formed in the platform of the main body 122 extending in the horizontal direction. The through holes 14 are also formed in the platform of the main body 122 extending in the horizontal direction, and the vias 123 are located on the outer side of the through holes 14. Further, as shown in FIG. 5 to FIG. 7, in some embodiments, the atomization base 1 further includes a top cover 13. The top cover 13 is disposed on the side of the holder 12 facing away from the base 11. The holder 12 is connected to the top cover 13, and the atomization core 2 is clamped and fixed between the holder 12 and the top cover 13. Therefore, the atomization core 2 can be clamped and fixed through cooperation of the holder 12 and the top cover 13. Specifically, the top cover 13 is disposed on the side of the main body 122 facing away from the base 11. The top cover 13 is connected to the main body 122, and the atomization core 2 is clamped and fixed between the main body 122 and the top cover 13. The holder 12 may be connected to the top cover 13 by a snap-fit. For example, the holder 12 is provided with grooves, and the top cover 13 is provided with protrusions. The holder 12 and the top cover 13 are fastened together through cooperation of the protrusions and the grooves. The main body 122 of the holder 12 is provided with a first central through hole 110. The top cover 13 is provided with a second central through hole 120. The first central through hole 110 and the second central through hole 120 are in communication with each other to jointly form the air outlet hole 103.

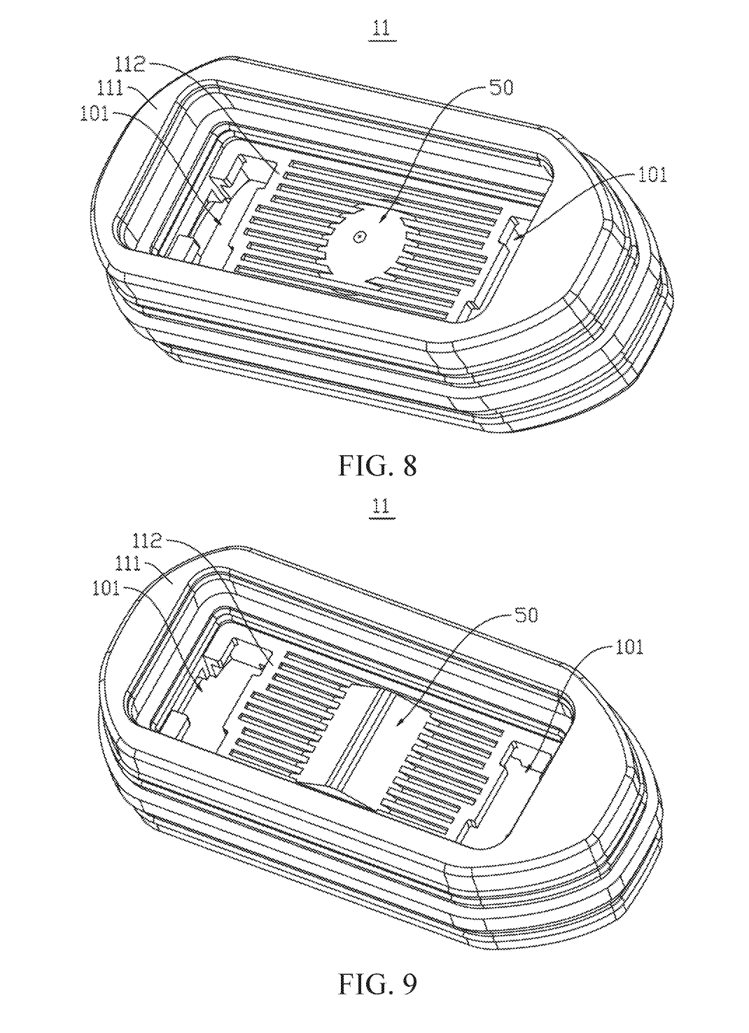

Further, as shown in FIG. 5 to FIG. 7, in some embodiments, the heating elements 21 are sheet-shaped. Because the sheet-shaped heating elements 21 have a very small thickness, sufficient supporting force is needed to ensure that the heating elements do not deform. Therefore, the atomization base 1 further includes at least two support members 15, and the support members 15 are configured to further support and fix the heating elements 21. The support members 15 are disposed between the heating elements 21 and the holder 12. The support members 15 may be an elastic member, which may be, for example, made of silicone, rubber, or silicone rubber. The quantity of the support members 15 may be the same as the quantity of the heating elements 21. In the embodiment shown in FIG. 5 to FIG. 7, two heating elements 21 and two support members 15 are provided in total. the surface of the main body 122 of the holder 12 facing away from the base 11 is concavely provided with at least two mounting slots 150. The number of the mounting slots 150, the number of the support members 15, the number of the through holes 14, and the number of the heating elements 21 are the same. Each mounting slot 150 is in communication with each through hole 14 in one-to-one correspondence. Each support member 15 is mounted in each mounting slot 150 in one-to-one correspondence. Each heating element 21 is mounted to the surface of each support member 15 facing away from the atomization cavity 102 in one-to-one correspondence. The top cover 13 covers the side of the heating element 21 facing away from the support member 15. As shown in FIG. 5 and FIG. 7 to FIG. 9, in some embodiments, the airflow guiding structure 5 is convexly disposed on a cavity bottom surface of the atomization cavity 102. Specifically, the cavity bottom surface of the atomization cavity 102 may be the surface of the base 11 facing the main body 122 of the holder 12. In other words, the cavity bottom surface of the atomization cavity 102 may be the surface of the bottom wall 112 of the base 11 facing the main body 122 of the holder 12. The cavity bottom surface of the atomization cavity 102 is a plane. The airflow guiding structure 5 has an airflow guiding surface 50. The airflow guiding surface 50 is inclined relative to the cavity bottom surface of the atomization cavity 102, and an angle of less than 90° is formed between the airflow guiding surface 50 and the cavity bottom surface of the atomization cavity 102. The airflow guiding surface 50 includes at least one of an inclined surface and a conical surface. That is, the airflow guiding surface 50 may be an inclined surface or a conical surface, or may also be a combination of an inclined surface and a conical surface. As shown in FIG. 8, in some embodiments, the airflow guiding surface 50 is a conical surface, that is, the airflow guiding structure 5 is approximately conical, and the conical surface has a tip. As shown in FIG. 9, in some other embodiments, the airflow guiding surface 50 includes two inclined surfaces. The two inclined surfaces are symmetrically disposed around a central axis of the air outlet hole 103, and the airflow guiding structure 5 is approximately triangular-prism-shaped. However, a transition plane is connected between the two inclined surfaces, so that the upper surface of the airflow guiding structure 5 is smoother.

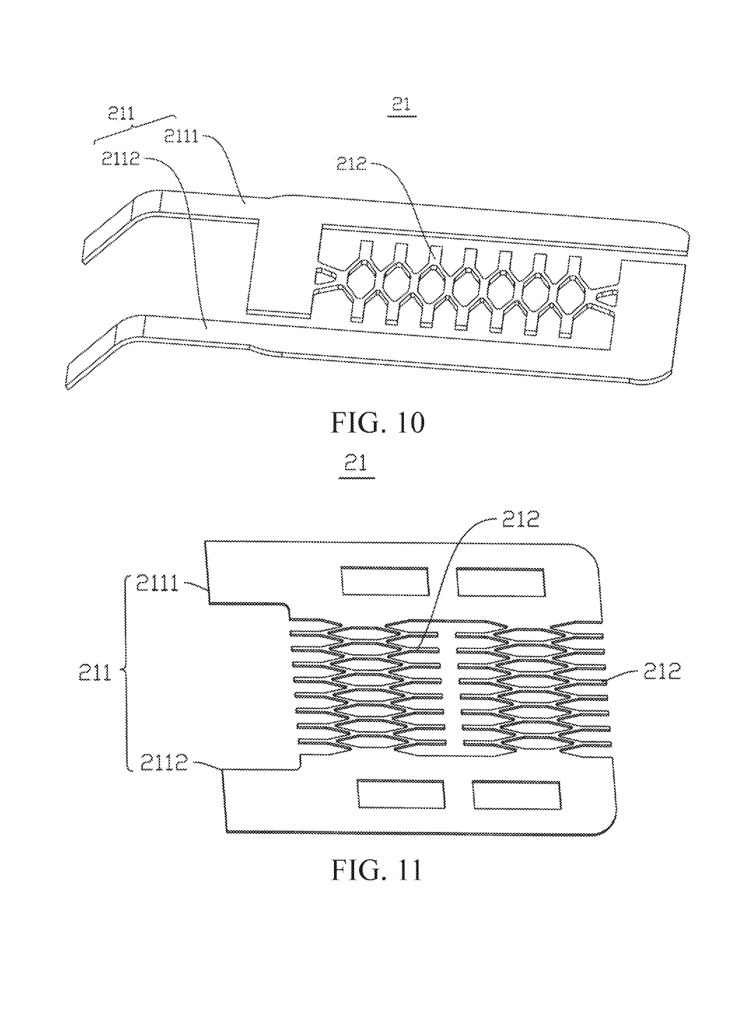

As shown in FIG. 10 and FIG. 11, in some embodiments, each of the heating elements 21 includes a conductive portion 211 and at least one heating portion 212 connected to the conductive portion 211. The conductive portion 211 is connected to the power supply unit 6, and the conductive portion 211 serves as a conductive electrode. The aerosol generating substrate is mainly heat and atomized at the heating portion 212. The heating portion 212 is exposed to the airflow channel. That is, the quantity of the heating portions 212 may be one, two, three, four, or the like. In the embodiment shown in FIG. 10 and FIG. 11, the conductive portion 211 includes a first part 2111 and a second part 2112. The first part 2111 and the second part 2112 respectively serve as a positive electrode and a negative electrode, and are connected to the power supply unit 6. Two opposite ends of each heating portion 212 are respectively connected to the first part 2111 and the second part 2112. In the embodiment shown in FIG. 10, each heating element 21 includes one heating portion 212, and the two opposite ends of the heating portion 212 are respectively connected to the first part 2111 and the second part 2112. In the embodiment shown in FIG. 11, each heating element 21 includes two heating portions 212, and the two opposite ends of each heating portion 212 are respectively connected to the first part 2111 and the second part 2112. The heating portions 212 are not in direct contact.

As shown in FIG. 10 and FIG. 11, the heating portion 212 has a planar network structure in some embodiments. Alternatively, in some other embodiments, the heating portion 212 may be helical. Correspondingly, as described above, the first circuit board 61 is connected to the heating element 21 through the conductive post 611. The conductive post 611 is connected to the conductive portion 211 after sequentially passing through the first mounting hole 101 and the via 123. Specifically, each conductive portion 211 covers the corresponding via 123, and the end of the conductive post 611 away from the first circuit board 61 abuts against the position of the conductive portion 211 exposed to the via 123, thereby implementing an electrical connection between the first circuit board 61 and the heating element 21.

In some embodiments, when each of the heating elements 21 includes at least two heating portions 212, the at least two heating portions 212 are electrically connected in parallel. Alternatively, at least two of the heating elements 21 are electrically connected in parallel. Alternatively, two heating elements 21 are electrically connected in parallel, and at least two heating portions 212 of each heating element 21 are also electrically connected in parallel. Because different heating portions 212 or heating elements 21 are electrically connected in parallel on the circuit of the power supply unit 6, the power supply unit 6 may separately control on/off, output power, and the like of each heating element 21 or each heating portion 212. Each heating element 21 or each heating portion 212 is set to a different output power, so that the vapor generation amount, the vapor generation rate, and the like can be adjusted.

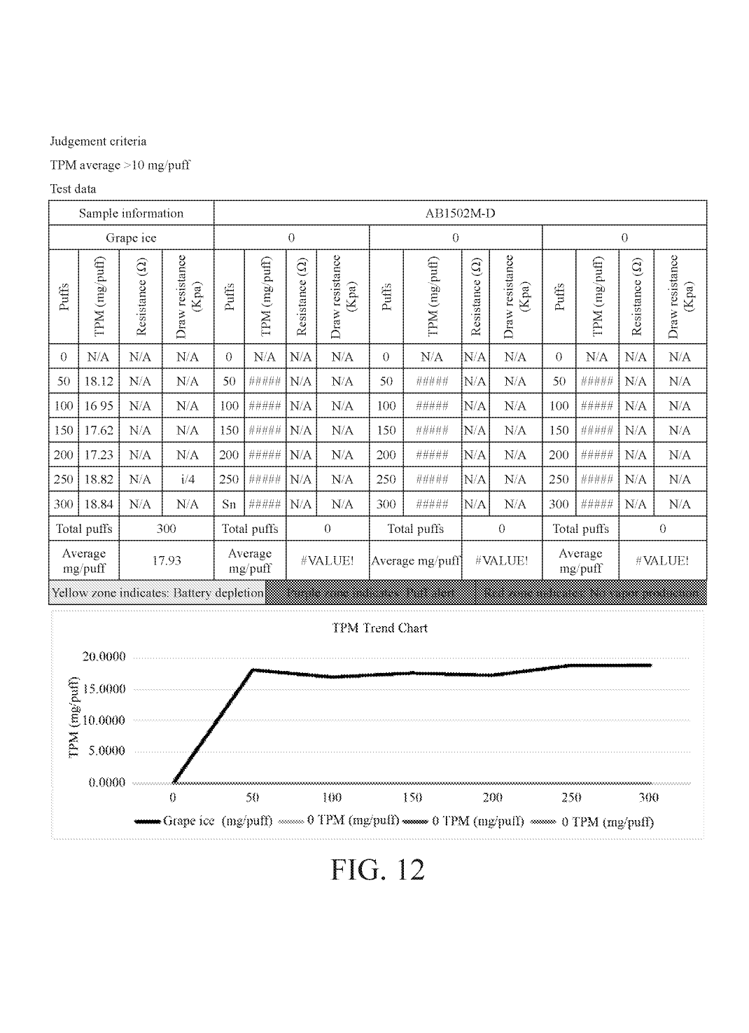

When two heating elements 21 having two heating portions shown in FIG. 11 are used, the area of the atomization region is large, and the entire power of the atomization core 2 is large. As shown in FIG. 12, it is found that the power of the atomization core 2 can reach 30 W, and the Total Particle Measure (TPM, i.e., average atomization output, namely the amount of vapor generated per puff) is 17.9 mg/puff. The TPM exceeds the standard value (10 mg/puff) by 7.9 mg/puff.

Further, as shown in FIG. 4 to FIG. 7, in some embodiments, the atomization core 2 further includes at least one liquid guide body 22. The liquid guide body 22 includes an atomization surface 222 and a liquid absorbing surface 221 that are oppositely disposed. The liquid absorbing surface 221 is configured to directly contact the aerosol generating substrate, and the aerosol generating substrate gradually penetrates from the liquid absorbing surface 221 to the atomization surface 222. The atomization surface 222 faces the atomization cavity 102, and the heating element 21 is disposed on the atomization surface 222 and configured to heat and atomize the aerosol generating substrate that penetrates into the atomization surface 222. The airflow guiding structure 5 is located on one side of the atomization surface 222. In the embodiment shown in FIG. 4 to FIG. 7, the atomization core 2 includes two liquid guide bodies 22, and the top cover 13 is provided with two second mounting holes 130. The two liquid guide bodies 22 are respectively embedded and fixed in the two second mounting holes 130. Each liquid guide body 22 has a liquid absorbing surface 221 and an atomization surface 222, and each heating element 21 is correspondingly disposed on one atomization surface 222. Alternatively, in some other embodiments, one liquid guide body 22 may also be provided, that is, the plurality of different heating elements 21 are disposed on the atomization surface 222 of one liquid guide body 22.

As shown in FIG. 2 and FIG. 3, in some embodiments, the atomizer further includes a liquid storage member 7, and the liquid absorbing surface 221 of the liquid guide body 22 is disposed toward a bottom surface of the liquid storage member 7. Specifically, the atomizer further includes a mouthpiece 4. The mouthpiece 4 is provided with a mouthpiece hole 40. The mixed fluid formed by the mixture of the aerosol and air in the atomization cavity 102 overflows to the outside of the atomizer through the mouthpiece hole 40, and the user may take a puff at the mouthpiece 4. The liquid storage member 7 has a top surface and a bottom surface that are oppositely disposed. The top surface of the liquid storage member 7 faces the side of the mouthpiece 4, and the bottom surface of the liquid storage member 7 faces away from the side of the mouthpiece 4. The liquid storage member 7 is provided with a third central through hole, that is, the liquid storage member 7 is ring-shaped and encloses to form the third central through hole. Two opposite ends of the third central through hole are respectively in communication with the air outlet hole 103 of the atomization base 1 and the mouthpiece hole 40, so that the mixed fluid formed by the mixture of the aerosol and air in the atomization cavity 102 sequentially flows through the air outlet hole 103, the third central through hole, and the mouthpiece hole 40, and then is inhaled by the user. For the airflow path, reference may be made to a dashed line with an arrow in FIG. 2.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
an atomization base, the atomization base being provided with an airflow channel, the airflow channel having an air inlet hole, an air outlet hole, and an atomization cavity, the atomization cavity being respectively in communication with the air inlet hole and the air outlet hole, an airflow guiding structure being provided in the atomization cavity, the airflow guiding structure being disposed toward the air outlet hole; and
an atomization core disposed on the atomization base and being in fluid communication with the atomization cavity, the atomization core comprising at least two heating elements, adjacent heating elements of the at least two heating elements being spaced apart.

2. The atomizer of claim 1, wherein the atomization base comprises a base and a holder,
wherein the base and the holder jointly enclose to form the atomization cavity, and
wherein the airflow guiding structure is formed on the base.

3. The atomizer of claim 2, wherein the atomization core is disposed on the holder,
wherein the base is provided with first mounting holes that run through a surface of the base facing the atomization core and a surface of the base facing away from the atomization core,
wherein the atomizer further comprises a first circuit board configured to connect to a power supply unit, the first circuit board being disposed on a side of the base facing away from the atomization core, and
wherein a plurality of conductive posts are disposed on the first circuit board, and the plurality of conductive posts are connected to the at least two heating elements after passing through the first mounting holes.

4. The atomizer of claim 3, wherein the holder comprises a main body and support legs connected to one another, the atomization core being disposed on the main body, and
wherein the support legs are at least partially located on a side of the base facing away from the atomization core and the first circuit board abuts against the support legs, and/or the main body is provided with a plurality of vias in one-to-one correspondence with the plurality of conductive posts, the plurality of conductive posts being connected to the at least two heating elements after sequentially passing through the first mounting holes and the plurality of vias.

5. The atomizer of claim 1, wherein the airflow guiding structure is convexly disposed on a cavity bottom surface of the atomization cavity,
wherein the airflow guiding structure has an airflow guiding surface, and
wherein the airflow guiding surface comprises at least one of an inclined surface and a conical surface.

6. The atomizer of claim 1, wherein the at least two heating elements are spaced apart along two opposite sides of the airflow guiding structure.

7. The atomizer of claim 1, wherein each heating element of the at least two heating elements comprises a conductive portion and at least one heating portion connected to the conductive portion.

8. The atomizer of claim 7, wherein each heating element comprises at least two heating portions, and
wherein at least two of the heating portions are electrically connected in parallel.

9. The atomizer of claim 8, wherein at least two heating elements are electrically connected in parallel.

10. The atomizer of claim 1, wherein each heating element of the at least two heating elements is sheet-shaped.

11. An electronic atomization device, comprising:
a power supply unit; and
the atomizer of claim 1, the atomizer being connected to the power supply unit.
